(19) United States
(12) Patent Application Publication
(10) Pub. No.: US 2025/0042178 A1
(43) Pub. Date: Feb. 6, 2025

(54) LASER PRINTING APPARATUS

(71) Applicant: Keyence Corporation, Osaka (JP)

(72) Inventors: Keisuke KANDA, Osaka (JP); Junya ONODA, Osaka (JP); Daishi WATANABE, Osaka (JP); Yuri ITO, Osaka (JP)

(73) Assignee: Keyence Corporation, Osaka (JP)

(21) Appl. No.: 18/747,487

(22) Filed: Jun. 19, 2024

(30) Foreign Application Priority Data
Jul. 31, 2023 (JP) 2023-124256

(51) Int. Cl. B41J 2/47

(52) U.S. Cl. CPC B41J 2/47

(57) ABSTRACT

A laser printing apparatus includes: an input interface for setting a printing pattern on a setting plane; a first selection unit that displays a plurality of different types of materials on a display unit and selects one thereof; a second selection unit that displays a plurality of different types of laser printing methods corresponding to a workpiece of a type on the display unit based on the type of a material selected by the first selection unit, and selects any one thereof; and a printing condition setting unit that sets a printing condition for printing the printing pattern on the workpiece of the material type by a laser printing method based on the printing pattern set by the input interface, the type of the material selected by the first selection unit, and a type of the laser printing method selected by the second selection unit.

### CROSS-REFERENCE TO RELATED APPLICATIONS

The present application claims foreign priority based on Japanese Patent Application No. 2023-124256, filed Jul. 31, 2023, the contents of which are incorporated herein by reference.

### BACKGROUND OF THE INVENTION

### 1. Technical Field

The disclosure relates to a laser printing apparatus.

### 2. Description of the Related Art

JP 2012-148307A discloses a laser marking apparatus including a printing condition setting device as an example of a laser printing apparatus. Specifically, the printing condition setting device disclosed in JP 2012-148307A generates a plurality of printing conditions by changing two of printing parameters constituting the printing conditions of laser light, such as a scanning speed of the laser light and a laser output. The laser marking apparatus according to JP 2012-148307A performs printing a plurality of times based on each of the printing conditions and causes a user to select a desired printing result.

According to JP 2012-148307A, printing parameters can be set to appropriate values by determining a set of the printing parameters corresponding to a desired printing result.

By the way, it is considered that an appropriate printing condition may vary depending on a type of a material of a printing target and a type of a laser printing method.

Therefore, a method of causing a user to select one from a plurality of different candidates each having a set of a type of a material and a type of a laser printing method and setting a printing condition according to the selection is considered.

However, in the case of the method as described above, it is assumed that the number of candidates increases excessively as types of materials and laser printing methods increase. For example, in a case where there are 10 types of materials and there are 5 types of laser printing methods, the number of candidates is 10×5=50. If the number of candidates excessively increases, the usability of the laser printing apparatus is impaired, which is disadvantageous.

### SUMMARY OF THE INVENTION

The disclosure has been made in view of such a point, and an object thereof is to appropriately set a printing condition without impairing usability of a laser printing apparatus.

According to one embodiment of the disclosure, a laser printing apparatus includes a laser light output unit that generates laser light based on excitation light and outputs the laser light and a laser light scanning unit that irradiates a printing target with the laser light output from the laser light output unit and performs two-dimensional scanning in a printing region on a surface of the printing target, the laser printing apparatus controlling the laser light output unit and the laser light scanning unit to print a predetermined printing pattern in the printing region.

According to the one embodiment, the laser printing apparatus includes: a display unit that displays a setting plane corresponding to the printing region; a printing pattern setting unit that sets the printing pattern on the setting plane displayed on the display unit; a first selection unit that displays a plurality of different types of materials forming the printing target on the display unit, and selects any one type based on a user operation; a second selection unit that displays, based on the type of a material selected by the first selection unit, a plurality of different types of laser printing methods corresponding to the printing target of the type on the display unit, and selects any one laser printing method based on a user operation; and a printing condition setting unit that sets a printing condition for printing the printing pattern on the printing target of the type of the material by the laser printing method based on the printing pattern set by the printing pattern setting unit, the type of the material selected by the first selection unit, and a type of the laser printing method selected by the second selection unit.

According to the one embodiment, the laser printing apparatus causes the first selection unit to select the type of the material, then displays a plurality of different laser printing methods corresponding to the type on the display unit, and causes the second selection unit to select one of them. As a result, options can be displayed in stages, and the number of options simultaneously displayed on the display unit can be reduced. This is effective in terms of ensuring the usability of the laser printing apparatus. In addition, there is no change in selecting each of the material type and the laser printing method type, and thus, the printing condition can be appropriately set. In this manner, the printing condition can be appropriately set without impairing the usability of the laser printing apparatus.

In addition, according to another embodiment of the disclosure, the laser printing apparatus may further include a method storage unit that stores one or more of a black carving method, a white carving method, a glossy method 1, a glossy method 2 a deep engraving method, and a shallow engraving method in association with each other, as the laser printing method selected by the second selection unit for each type of a material selected by the first selection unit, and the second selection unit may display a plurality of laser printing methods corresponding to the type of the material selected by the first selection unit on the display unit based on contents stored in the method storage unit.

The another embodiment contributes to appropriate setting of the printing condition.

In addition, according to still another embodiment of the disclosure, the laser printing apparatus may further include a third selection unit that displays a printing quality in the laser printing method selected by the second selection unit as a plurality of different quality levels on the display unit, and selects any one quality level based on a user operation, and the printing condition setting unit may set the printing condition based on the quality level selected by the third selection unit in addition to the printing pattern set by the printing pattern setting unit, the type of the material selected by the first selection unit, and the type of the laser printing method selected by the second selection unit.

According to the still another embodiment, it is possible to more appropriately set the printing condition by further considering the quality level in addition to the type of the material and the type of the laser printing method.

In addition, according to still another embodiment of the disclosure, the laser printing apparatus may further include a printing time calculation unit that calculates a printing time required for printing the printing pattern set by the printing pattern setting unit on the printing target of the type selected by the first selection unit for each laser printing method that needs to be selected by the second selection unit, and the second selection unit may display the plurality of different laser printing methods on the display unit, and display the printing time calculated by the printing time calculation unit in association with each of the laser printing methods displayed on the display unit.

According to the still another embodiment, since the printing time is displayed in association with each of the laser printing methods, even a user who is not accustomed to laser printing can set the printing condition so as to fall within a desired printing time. As a result, the usability of the laser printing apparatus can be improved.

In addition, according to still another embodiment of the disclosure, the laser printing apparatus may further include an image storage unit that stores at least one of a preview image and an illustration showing each laser printing method for each laser printing method that needs to be selected by the second selection unit, and the second selection unit may display the plurality of different laser printing methods on the display unit, and display at least one of the preview image and the illustration in association with each of the laser printing methods displayed on the display unit based on contents stored in the image storage unit.

According to the still another embodiment, since at least one of the preview image and the illustration is displayed in association with each of the laser printing methods, even the user who is not accustomed to laser printing can set the printing condition so as to achieve a desired appearance. As a result, the usability of the laser printing apparatus can be improved.

In addition, according to still another embodiment of the disclosure, the printing condition setting unit may generate a plurality of different printing conditions by setting two parameters among a plurality of different parameters constituting the printing condition as variable parameters, setting a remaining parameter as a fixed parameter, and changing the variable parameters, and select, for each laser printing method that needs to be selected by the second selection unit, the variable parameters corresponding to the laser printing method.

According to the still another embodiment, the variable parameters can be automatically selected in association with each of the laser printing methods. As a result, it is possible to more efficiently search for parameters in further tuning of the printing condition. Thus, the usability of the laser printing apparatus can be improved.

As described above, according to the disclosure, the printing condition can be appropriately set without impairing the usability of the laser printing apparatus.

### BRIEF DESCRIPTION OF THE DRAWINGS

FIG. 1 is a diagram illustrating an overall configuration of a laser printing system;

FIG. 2 is a block diagram illustrating a schematic configuration of a laser printing apparatus;

FIG. 3 is a flowchart illustrating processing related to setting of a printing condition;

FIG. 4 is a table illustrating materials of a workpiece and laser printing methods selectable according to each of the materials;

FIG. 5 is a table illustrating printing conditions according to each of the laser printing methods;

FIG. 6A is a view illustrating a screen displayed on a display unit;

FIG. 6B is a view illustrating a screen displayed on the display unit;

FIG. 6C is a view illustrating a screen displayed on the display unit;

FIG. 6D is a view illustrating a screen displayed on the display unit;

FIG. 6E is a view illustrating a screen displayed on the display unit;

FIG. 6F is a view illustrating a screen displayed on the display unit;

FIG. 6G is a view illustrating a screen displayed on the display unit;

FIG. 6H is a view illustrating a screen displayed on the display unit;

FIG. 6I is a view illustrating a screen displayed on the display unit;

FIG. 6J is a view illustrating a screen displayed on the display unit; and

FIG. 7 is a view corresponding to FIG. 6E, which illustrates a modification of a display screen.

### DETAILED DESCRIPTION

Hereinafter, embodiments of the present disclosure will be described with reference to the drawings. Note that the following description is given as an example.

Although laser printing using laser light will be described in the present embodiment, the disclosure can be applied to marking of those other than characters such as marking of figures regardless of the term “printing”. The marking of those other than characters includes marking of two-dimensional codes such as a barcode and a QR code (registered trademark) in addition to marking of figures such as “:” and “x”.

In the following description, instead of the term “laser printing”, this is sometimes referred to as “marking”, “processing”, or simply “printing”.

### Overall Configuration

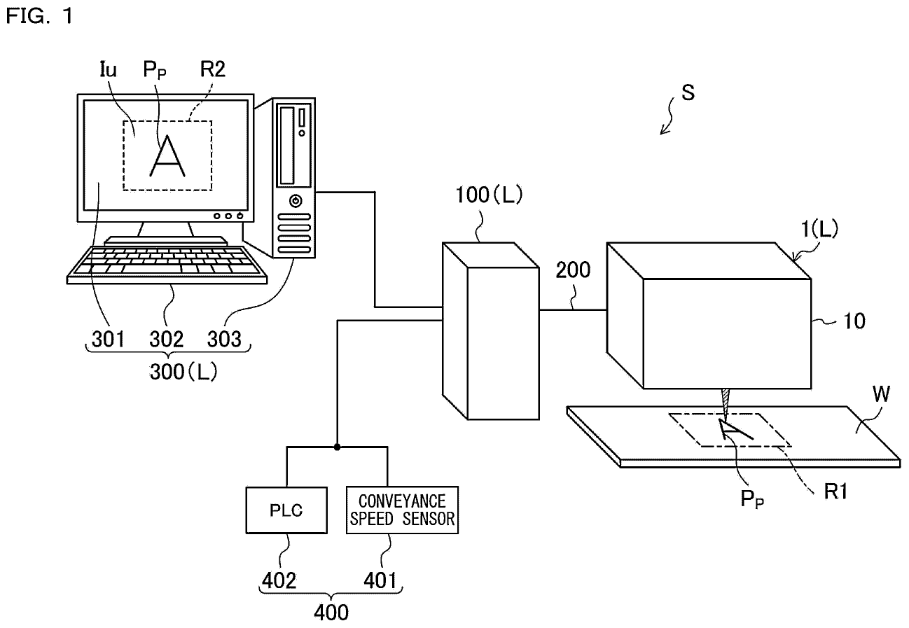

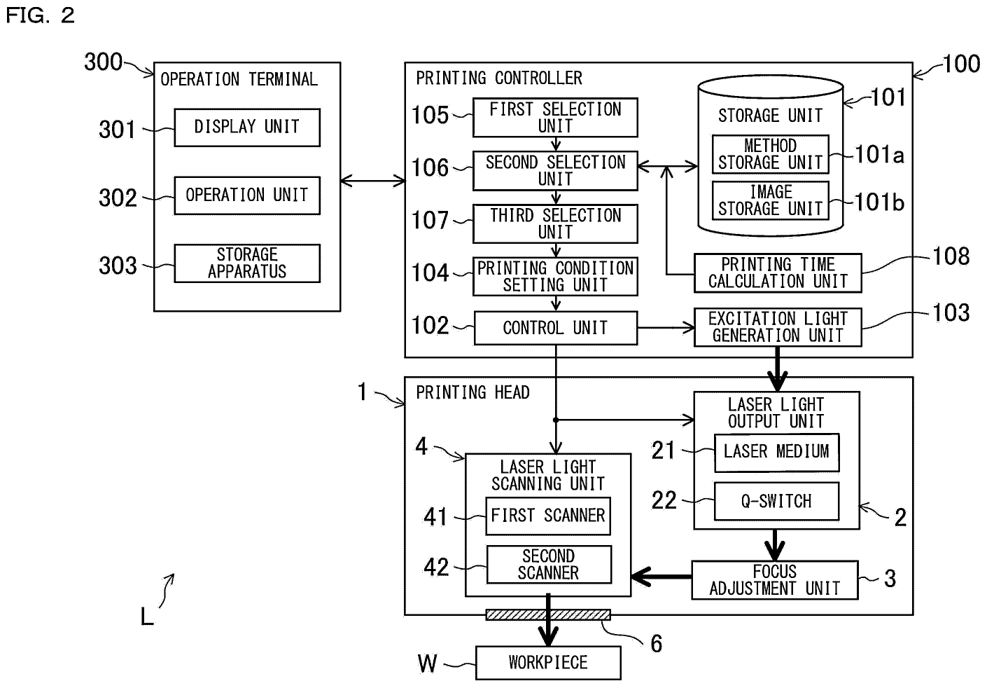

FIG. 1 is a diagram illustrating an overall configuration of a laser printing system S, and FIG. 2 is a diagram illustrating a schematic configuration of a laser printing apparatus L in the laser printing system S. The laser printing system S illustrated in FIG. 1 includes the laser printing apparatus L and an external device 400 connected thereto.

Among these, the laser printing apparatus L illustrated in FIGS. 1 and 2 is configured to print a predetermined printing pattern Pp in a printing region R1 by controlling a laser light output unit 2 and a laser light scanning unit 4 which will be described later.

Note that the printing region R1 here is a region set on the surface of a workpiece W, which is an object on which printing is performed, as illustrated in FIG. 1 and corresponds to a setting plane R2 in FIG. 1. For example, in FIG. 1, the printing region R1 is configured as a rectangular region. In addition, the setting plane R2 herein corresponds to a virtual plane that can be displayed on a display unit 301 of an operation terminal 300.

The laser printing apparatus L is configured to perform printing by irradiating the workpiece W with laser light generated in a printing head 1 and performing three-dimensionally scanning on the surface of the workpiece W. Note that the “three-dimensional scanning” here indicates a concept that collectively refers to a combination of a two-dimensional operation of scanning an irradiation position of laser light on the surface of the workpiece W (so-called “two-dimensional scanning”) and a one-dimensional operation of adjusting a focal position of laser light. Note that three-dimensional scanning is not essential. It is sufficient for the laser printing apparatus L to be capable of performing at least two-dimensional scanning.

In particular, the laser printing apparatus L according to the present embodiment can emit laser light having a wavelength included in a near-infrared (NIR) wavelength range, for example, a wavelength around 1064 nm as the laser light for printing on the workpiece W. This wavelength corresponds to the near-infrared (NIR) wavelength range. It is a matter of course that laser light having another wavelength may be used for the printing on the workpiece W. In addition, in the following description, the laser light for performing printing on the workpiece W is sometimes referred to as “printing laser light” to be distinguished from another laser light.

As illustrated in FIGS. 1 and 2, the laser printing apparatus L according to the present embodiment includes the printing head 1, a printing controller 100, a connection cable 200, and the operation terminal 300.

Among these, the printing controller 100 can set settings related to the printing pattern Pp, for example, a printing condition for printing the desired printing pattern Pp, and is configured as a controller configured to control the printing head 1.

In addition, the printing head 1 can emit the printing laser light toward the printing region R1 by being controlled by the printing controller 100.

The printing head 1 and the printing controller 100 are separated from each other in the present embodiment, and are electrically and optically connected by the connection cable 200. The connection cable 200 is configured using, for example, at least one of an electrical wiring and an optical fiber cable.

More typically, one of the printing head 1 and the printing controller 100 can be incorporated into the other to be integrated. In this case, the optical fiber cable or the like can be omitted as appropriate.

In addition, the operation terminal 300 includes, for example, a central processing unit (CPU) and a memory, and is connected to the printing controller 100 so as to be capable of transmitting and receiving an electrical signal in a wired or wireless manner.

Note that the operation terminal 300 is configured using a personal computer such as a desktop computer or a laptop computer in the present embodiment, but the disclosure is not limited to such a configuration. For example, the operation terminal 300 may be configured using a dedicated terminal that is connectable to the laser printing apparatus L such as a touch panel console. In addition, the operation terminal 300 can also be integrated into the printing controller 100, for example.

The operation terminal 300 functions as a terminal configured to set various printing conditions and indicate information related to laser printing to a user. The operation terminal 300 includes the display unit 301 configured to display information to the user, an operation unit 302 that receives an operation input from the user (hereinafter, referred to simply as “user operation”), and a storage apparatus 303 configured to store various types of information.

The display unit 301 can display the setting plane R2 corresponding to the printing region R1. In addition, an input interface Iu for receiving an input of the printing pattern Pp is disposed on the setting plane R2 as illustrated in FIG. 1. The input interface Iu includes user interfaces such as a frame indicating a range of the setting plane R2 and a figure indicating a position of the printing pattern Pp on the setting plane R2. The input interface Iu can receive the input of the printing pattern Pp and display contents of the received printing pattern Pp on the setting plane R2 based on the user operation.

The input interface Iu is an example of a “printing pattern setting unit” in the present embodiment in terms of being capable of setting the printing pattern Pp on the setting plane R2.

Specifically, the display unit 301 is configured using, for example, a liquid crystal display or an organic EL panel. When the operation terminal 300 is incorporated in the printing controller 100 or the touch panel console is used, a display screen provided on the printing controller 100 or the console can be used as the display unit.

The operation unit 302 can be configured using a keyboard and a pointing device. Here, the pointing device includes a mouse, a joystick, or the like. When the operation terminal 300 is incorporated in the printing controller 100 or the touch panel console is used, a switch, a button, or the like provided in the printing controller 100 or the console can be used as the operation unit.

The operation terminal 300 configured as described above can set the printing pattern Pp that needs to be printed on the workpiece W and the printing condition for printing the printing pattern Pp based on the user operation on the input interface Iu.

The printing condition may be a combination of one or more of laser power, a scan speed, a Q-switch frequency, a defocus amount (spot variable value), the number of times of printing, and a scanning line interval.

Here, the laser power is a target output of the printing laser light. The scan speed is a scanning speed of the printing laser light on the workpiece W. The defocus amount indicates a size of a deviation between a focal position of the printing laser light and the surface of the workpiece W in a height direction. When the defocus amount is set to a non-zero value, a spot diameter of the printing laser light can be changed. The number of times of printing indicates the number of times of repeatedly scanning each line element when the printing pattern Pp is decomposed into a plurality of line elements. The scanning line interval indicates an interval (in particular, an interval in a direction orthogonal to a scanning direction) between scanning lines constituting each of the line elements.

The printing pattern Pp and the printing condition set by the operation terminal 300 are output to the printing controller 100 and stored in a storage unit 101 of the printing controller 100. Hereinafter, a combination of the printing pattern Pp and the printing condition is referred to as “printing settings”. The storage apparatus 303 of the operation terminal 300 may store the printing settings as necessary.

As illustrated in FIG. 2, a printing condition setting unit 104 configured to define the printing condition in the printing settings is interposed between the operation terminal 300 and the storage unit 101. The printing condition setting unit 104 executes processing related to the setting of the printing condition. Details of the printing condition setting unit 104 will be described later.

The external device 400 is connected to the printing controller 100 as necessary. In the example illustrated in FIG. 1, a conveyance speed sensor 401 and a programmable logic controller (PLC) 402 are provided as the external device 400.

The conveyance speed sensor 401 is configured using, for example, a rotary encoder, and can detect a conveyance speed of the workpiece W. The conveyance speed sensor 401 outputs a signal (detection signal) indicating a result of the detection to the printing controller 100. The printing controller 100 controls two-dimensional scanning or the like of printing laser light based on the detection signal input from the conveyance speed sensor 401.

The PLC 402 is configured using, for example, a microprocessor, and can input a control signal to the printing controller 100. The PLC 402 is used to control the laser printing system S according to a predetermined sequence.

In addition to the above-described devices and apparatuses, an apparatus configured to perform operation and control, a computer configured to perform various other processes, a storage apparatus, a peripheral device, and the like can be connected to the laser printing apparatus L in a wired or wireless manner.

Hereinafter, a hardware configuration of each of the printing controller 100 and the printing head 1 and a configuration related to the control of the printing head 1 by the printing controller 100 will be described in order.

### <Printing Controller 100>

As illustrated in FIG. 2, the printing controller 100 includes the storage unit 101 that stores the printing settings described above, a control unit 102 that controls the printing head 1 based on the printing settings, and an excitation light generation unit 103 that generates laser excitation light (excitation light).

### (Storage Unit 101)

The storage unit 101 is configured to store printing settings defined via the operation terminal 300 and output the stored contents to the control unit 102 as necessary.

Specifically, the storage unit 101 is configured using a volatile memory, a non-volatile memory, a hard disk drive (HDD), a solid state drive (SSD), or the like, and can temporarily or consistently store information indicating the printing settings. Note that the storage apparatus 303 may also serve as the storage unit 101 when the operation terminal 300 is incorporated in the printing controller 100.

### (Control Unit 102)

The control unit 102 executes printing or the like on the workpiece W by controlling at least the excitation light generation unit 103 of the printing controller 100 and the laser light output unit 2 and the laser light scanning unit 4 of the printing head 1 based on printing settings stored in the storage unit 101.

Specifically, the control unit 102 has a CPU, a memory, and an input/output bus, and generates a control signal based on a signal indicating information input via the operation terminal 300 and a signal indicating the printing condition read from the storage unit 101. The control unit 102 controls printing on the workpiece W by outputting the control signal generated in this manner to each unit of the laser printing apparatus L.

For example, when printing processing of the workpiece W is started, the control unit 102 reads laser power stored in the storage unit 101 and outputs a control signal generated based on the laser power to the excitation light generation unit 103 to control the generation of laser excitation light.

In addition, when printing is actually performed on the workpiece W, the control unit 102 reads the printing pattern Pp stored in the storage unit 101, for example, and outputs a control signal generated based on the printing pattern Pp to the laser light scanning unit 4 to two-dimensionally scan printing laser light. In this manner, the control unit 102 can control the laser light scanning unit 4 so as to implement the two-dimensional scanning of the printing laser light.

### (Excitation Light Generation Unit 103)

The excitation light generation unit 103 oscillates laser light according to a drive current, and condenses and outputs the oscillated laser light as laser excitation light (excitation light). Specifically, the excitation light generation unit 103 according to the present embodiment includes an excitation light source that oscillates the laser light and a light focusing unit that condenses the laser. The excitation light source can be configured using, for example, a laser diode (LD). The light focusing unit can be configured using, for example, a focusing lens.

The excitation light output from the excitation light generation unit 103 is input to the printing head 1 via the optical fiber cable or the like. Note that the excitation light generation unit 103 is not necessarily provided in the printing controller 100, and may be provided in the printing head 1.

### (Other Constituent Elements)

The printing controller 100 also includes a first selection unit 105, a second selection unit 106, a third selection unit 107, and a printing time calculation unit 108. Although details will be described later, the first selection unit 105, the second selection unit 106, the third selection unit 107, and the printing time calculation unit 108 execute processing related to a printing condition similarly to the printing condition setting unit 104 described above. Note that these elements may be mounted on the operation terminal 300 instead of the printing controller 100.

### <Printing Head 1>

The printing head 1 includes the laser light output unit 2 and the laser light scanning unit 4. The laser light output unit 2 generates laser light (printing laser light) based on excitation light, and outputs the laser light. The laser light scanning unit 4 irradiates the workpiece W with the laser light output from the laser light output unit 2, and performs two-dimensional scanning in the printing region R1 on the surface of the workpiece.

In addition, the printing head 1 further includes a focus adjustment unit 3 interposed between the laser light output unit 2 and the laser light scanning unit 4. The focus adjustment unit 3 is configured to adjust a focal position of the printing laser light. Note that the focus adjustment unit 3 is not essential.

### (Laser Light Output Unit 2)

The laser light output unit 2 is configured to generate near-infrared laser light for printing based on the excitation light generated by the excitation light generation unit 103 and output the near-infrared laser light to the laser light scanning unit 4 via the focus adjustment unit 3.

Specifically, the laser light output unit 2 includes a so-called laser oscillator. The laser oscillator generates laser light having a predetermined wavelength based on laser excitation light, and amplifies the laser light to emit near-infrared laser light.

Although details are omitted, the laser oscillator includes a laser medium 21 that performs stimulated emission corresponding to laser excitation light to emit laser light, a Q switch 22 configured to pulse the laser light emitted from the laser medium 21, and a mirror (not illustrated) that resonates the laser light pulsed by the Q switch 22.

Particularly in the present embodiment, rod-shaped Nd:YVO₄ (yttrium vanadate) is used as the laser medium 21. As a result, the laser light output unit 2 can output laser light having a wavelength near 1064 nm (the above-described near-infrared laser light) as the printing laser light. However, rare earth-doped YAG, YLF, GdVO₄, and the like, for example, can be used as other laser media without being limited to this example. Various laser media 21 can be used in accordance with an application of the laser printing apparatus L In addition, it is also possible to combine the laser medium 21 with a wavelength conversion element to convert a wavelength of laser light to be output into an arbitrary wavelength. A wavelength changing element can be configured using one or more non-linear optical crystals. In addition, a so-called fiber laser using a fiber as the laser oscillator may be used.

### (Focus Adjustment Unit 3)

The focus adjustment unit 3 passes printing laser light output from the laser light output unit 2 and adjusts a focal position of the printing laser light. The printing laser light having passed through the focus adjustment unit 3 is incident on the laser light scanning unit 4.

Although details are omitted, the focus adjustment unit 3 includes, for example, an input lens that transmits the printing laser light output from the laser light output unit 2, a collimator lens that passes the printing laser light having passed through the input lens, an output lens that passes the printing laser light having passed through the input lens and the collimator lens, and a lens drive unit that moves the input lens.

When the focal position is adjusted, the lens drive unit is operated based on, for example, a control signal from the control unit 102. With this operation, a relative distance between the input lens and the output lens is changed while optical axes of the input lens, the collimator lens, and the output lens are kept coaxial with respect to the printing laser light. With this change, the focal position of the printing laser light with which the workpiece W is irradiated changes.

### (Laser Light Scanning Unit 4)

The laser light scanning unit 4 is configured to irradiate the workpiece W with laser light (printing laser light), which has been emitted from the laser light output unit 2 and passed through the focus adjustment unit 3, and to perform two-dimensional scanning on the surface of the workpiece W.

In the present embodiment, the laser light scanning unit 4 is configured using a so-called biaxial (X-axis and Y-axis) galvano scanner. That is, the laser light scanning unit 4 includes: a first scanner 41 configured to scan near-infrared laser light incident from the focus adjustment unit 3 in a first direction; and a second scanner 42 configured to scan the near-infrared laser light scanned by the first scanner 41 in a second direction.

Here, the second direction indicates a direction substantially orthogonal to the first direction. Accordingly, the second scanner 42 can scan the near-infrared laser light in the direction substantially orthogonal to the first scanner 41.

The laser light scanning unit 4 operates the first scanner 41 and the second scanner 42 according to printing settings created in advance, thereby deflecting the printing laser light toward the printing region R. The printing laser light deflected in this manner is transmitted through an emission window 6 provided in a housing of the printing head 1 and is emitted into the printing region R1. The desired printing pattern Pp can be printed in the printing region R1 by the printing laser light.

It is necessary to create printing settings suitable for a material of the workpiece W in order to print the desired printing pattern Pp. The laser printing apparatus L according to the present embodiment has a configuration designed to create such printing settings.

### <Printing Setting Creation Procedure>

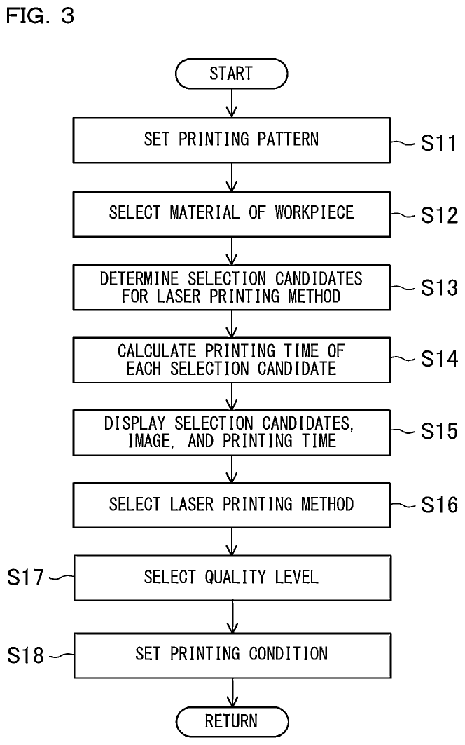

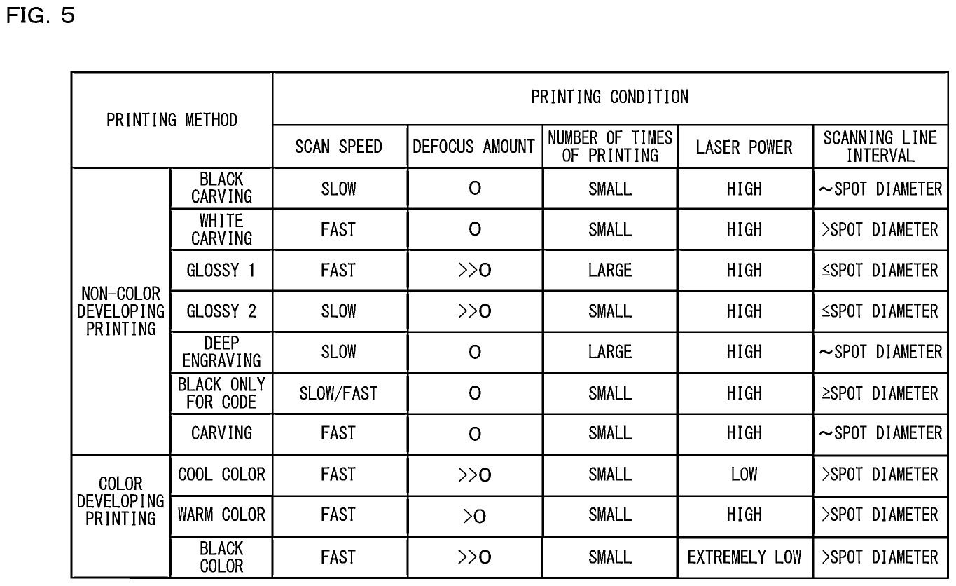

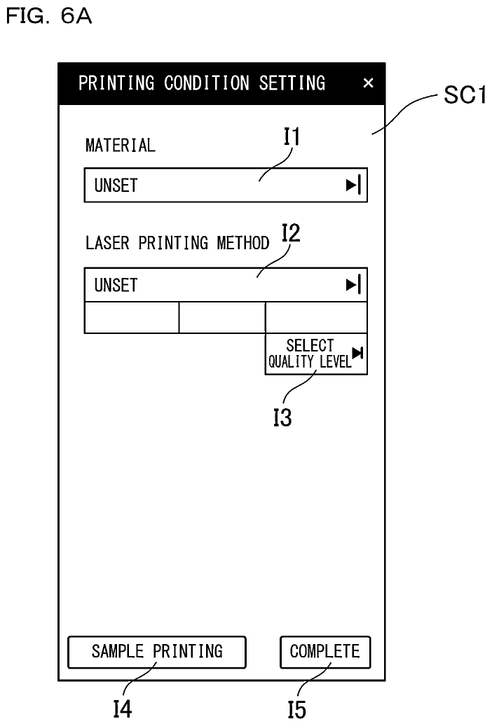

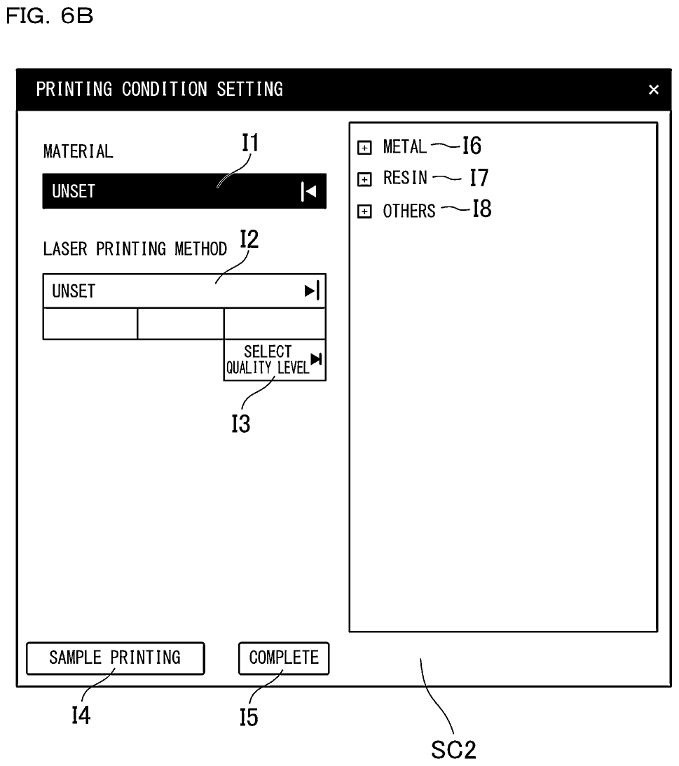

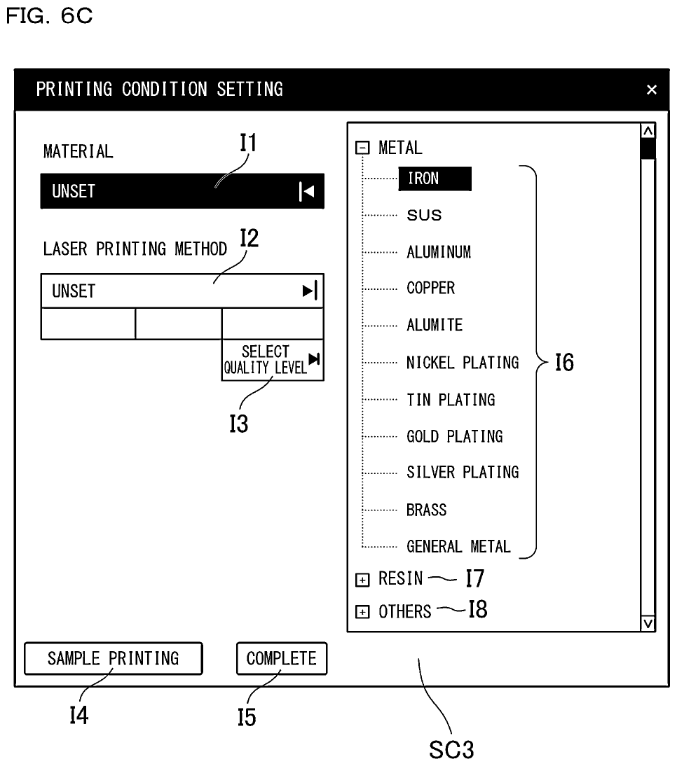

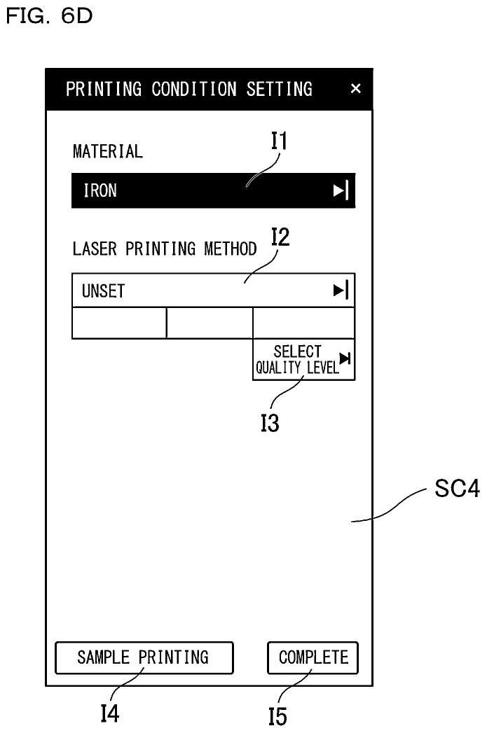

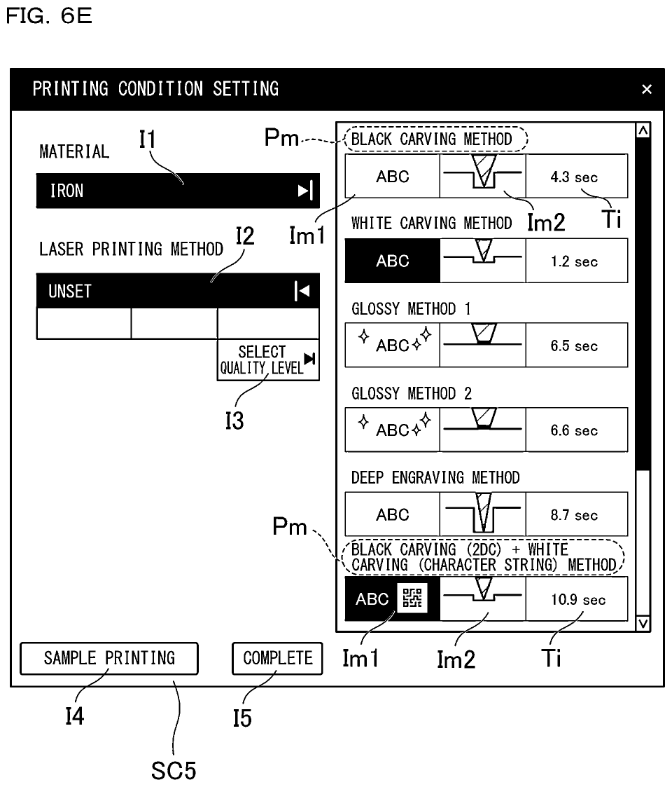

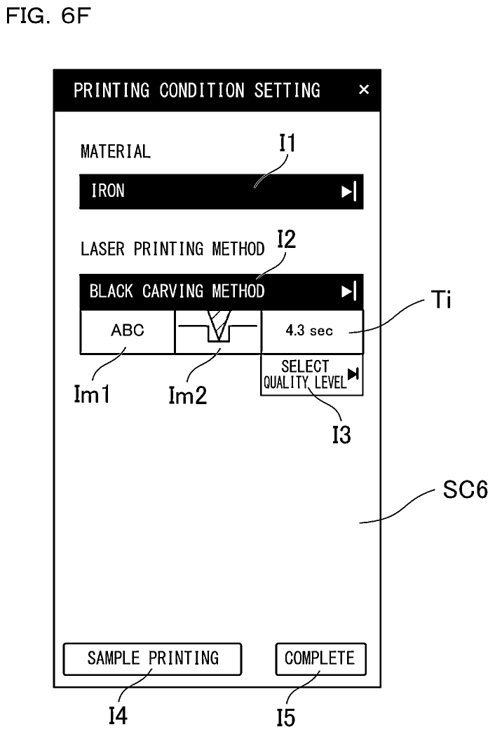

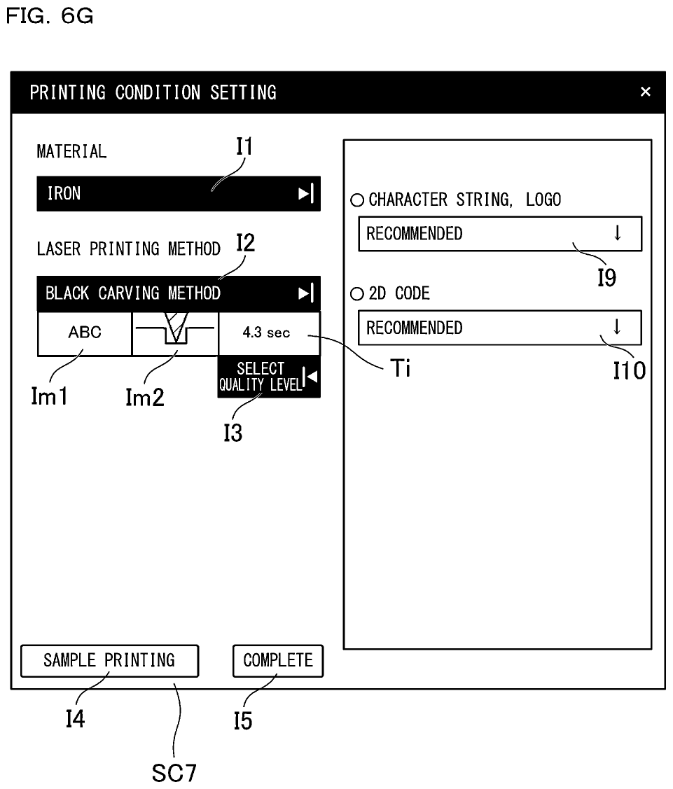

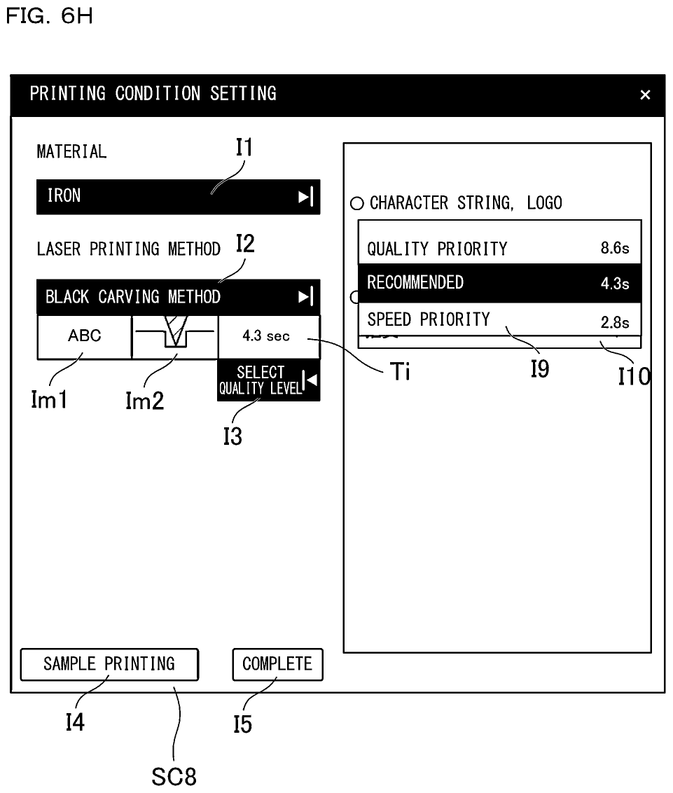

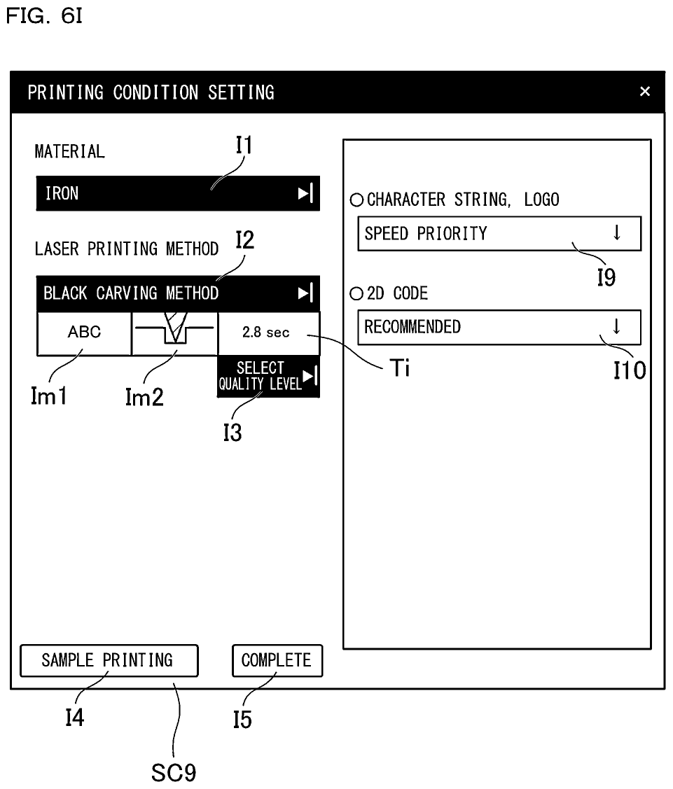

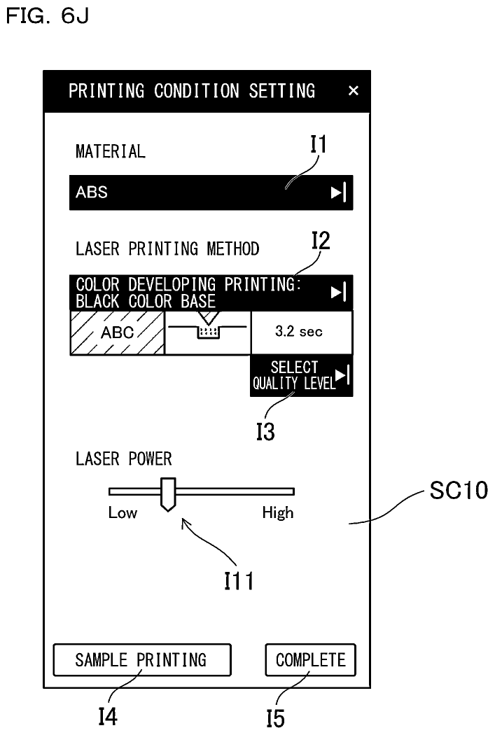

Hereinafter, a printing setting creation procedure will be described with reference to FIGS. 3, 4, 5, and 6A to 6J. FIG. 3 is a flowchart illustrating processing related to setting of a printing condition. FIG. A is a table illustrating materials of the workpiece W and laser printing methods selectable according to each of the materials. FIG. 5 is a table illustrating printing conditions according to each of the laser printing methods. FIGS. 6A to 6J are views illustrating screens displayed on the display unit 301.

First, in step S11, the printing controller 100 sets the printing pattern Pp on the setting plane R2 based on a user operation on the input interface Iu. The printing pattern Pp may be stored in the storage unit 101 in advance, or may be input each time via the operation terminal 300 or changed via the operation terminal 300.

More specifically, contents set in step S11 include contents, sizes, rotational postures, and layouts of character strings and/or figures constituting the printing pattern Pp. Note that a plurality of the workpieces W or only one workpiece W may be displayed on the setting plane R2 although details are omitted. In addition, a plurality of the printing patterns Pp may be set on one workpiece W Subsequently, in step S12, the first selection unit 105 displays a plurality of different types of materials forming the workpiece W on the display unit 301, and selects any one type based on a user operation.

Here, the plurality of different types of materials include metal, resins (synthetic resins), and the other materials. The first selection unit 105 according to the present embodiment can select at least a material belonging to either metal or resins (synthetic resins). Each of the metal and the resins is subdivided into one or more selection items. The other materials include, for example, ceramics.

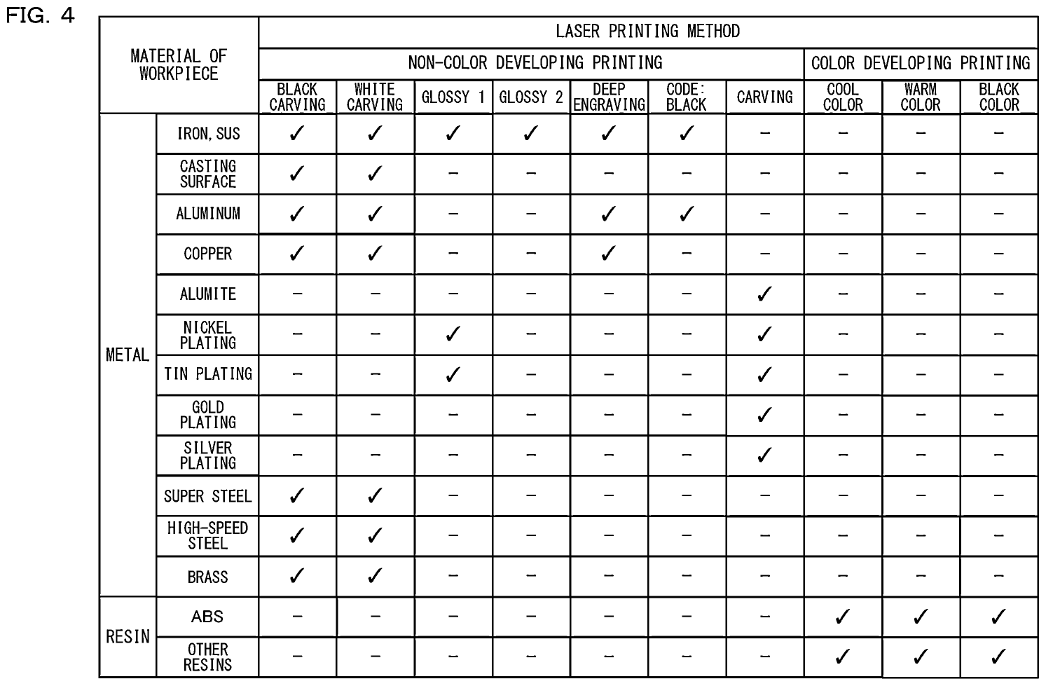

For example, as illustrated in FIG. 4, in the present embodiment, as selection items belonging to metal, an item corresponding to iron or SUS, an item corresponding to a casting surface of cast iron, an item corresponding to aluminum, an item corresponding to copper, an item corresponding to alumite, an item corresponding to nickel plating, an item corresponding to tin plating, an item corresponding to gold plating, an item corresponding to silver plating, an item corresponding to super steel, an item corresponding to high-speed steel, and an item corresponding to brass are displayed on the display unit 301. For example, in a case where a workpiece W made of aluminum is to a printing target, the item corresponding to aluminum is selected. Similarly, in a case where a gold-plated workpiece W is set as a printing target, the item corresponding to gold plating is selected.

In addition, an item corresponding to cation coating, an item corresponding to alumina, an item corresponding to zirconia, and an item corresponding to ferrite may be included in the selection items belonging to metal although not illustrated.

In addition, as illustrated in FIG. 4, an item corresponding to ABS and an item corresponding to other resins are displayed on the display unit 301 as selection items belonging to a resin in the present embodiment. For example, in a case where the workpiece W made of ABS is a printing target, the item corresponding to ABS is selected.

In addition, items corresponding to other resins may be further subdivided into an item corresponding to polypropylene, an item corresponding to polybutylene terephthalate, and the like although details are omitted.

Each of the selection items will be described with a specific example. For example, when the control process proceeds from step S11 to step S12, the display unit 301 displays a first screen SC1 illustrated in FIG. 6A. This display may be performed by the first selection unit 105 controlling the display unit 301. In the example of FIG. 6A, the first screen SC1 is a dialog that can be superimposed on another display.

As illustrated in FIG. 6A, a first interface I1, a second interface 12, a third interface 13, a fourth interface 14, and a fifth interface 15 are displayed on the first screen SC1.

The first interface I1 is a user interface for selecting a material type. The second interface 12 is a user interface for selecting a laser printing method. The third interface 13 is a user interface for selecting a quality level. The fourth interface 14 is a user interface for starting processing related to sample printing. The fifth interface 15 is a user interface for completing the processing related to the setting of a printing condition.

Here, when the first interface I1 receives a click operation or the like, display contents of the display unit 301 transition from the first screen SC1 to a second screen SC2. Details of the second screen SC2 are as illustrated in FIG. 6B.

As illustrated in FIG. 6B, a sixth interface 16, a seventh interface 17, and an eighth interface 18 are displayed on the second screen SC2 in addition to the first interface I1 and the like described above.

The sixth interface 16 is a user interface for causing the first selection unit 105 to select the item belonging to metal. The seventh interface 17 is a user interface for causing the first selection unit 105 to select an item belonging to a resin. The eighth interface 18 is a user interface for causing the first selection unit 105 to select an item belonging to the other materials.

Here, when the sixth interface 16 receives a click operation or the like, display contents of the display unit 301 transition from the second screen SC2 to a third screen SC3. Details of the third screen SC3 are as illustrated in FIG. 6C.

As illustrated in FIG. 6C, display contents of the sixth interface 16 are unfolded into a plurality of tree-like items on the third screen SC3. The respective unfolded items function as the selection items belonging to metal. When the sixth interface 16 repeatedly receives a click operation or the like, a transition can be made between a tree display as illustrated in FIG. 6C and a display as illustrated in FIG. 6B. Such a tree display is effective for sorting in a case where there are a large number of material types constituting the selection items.

In addition, for example, when printing is performed on the workpiece W made of metal, the items of resins are displayed in a folded state as illustrated in FIG. 6C. In this manner, the usability of the laser printing apparatus L can be improved by selectively using whether or not to perform the tree display according to major classification of materials.

Here, it is possible to cause the first selection unit 105 to select “iron” as a material type of the workpiece W, for example, by performing a click operation or the like on an item “iron”. Thereafter, when the first interface I1 receives a click operation or the like again, display contents of the display unit 301 transition from the third screen SC3 to a fourth screen SC4. Details of the fourth screen SC4 are as illustrated in FIG. 6D.

As illustrated in FIG. 6D, the fourth screen SC4 has the same configuration as the first screen SC1 in FIG. 6A except for display contents of the first interface I1. The first interface I1 of FIG. 6D displays that the material type of the workpiece W is “iron”.

Subsequently, from step S13 to step S16, the second selection unit 106 displays types of a plurality of different of laser printing methods corresponding to the workpiece W of the type on the display unit 301 based on the material type selected by the first selection unit 105, and selects any one laser printing method based on a user operation.

Note that the “plurality of different laser printing methods” here refers to methods that are selectively used according to a hue of printing performed on the workpiece W, a surface state of the workpiece W, or a hue of the workpiece W as the printing target.

Here, laser printing methods selectively used according to the hue of printing performed on the workpiece W or the surface state of the workpiece W are related to, for example, the workpiece W made of metal. On the other hand, laser printing methods selectively used according to the hue of the workpiece W as the printing target are related to, for example, the workpiece W made of a resin.

In addition, a concept of “printing quality” is also used as a concept different from the “laser printing method” in the present embodiment. The “printing quality” here is not a classification according to the hue of printing performed on the workpiece W, the surface state of the workpiece W, or the hue of the workpiece W as the printing target, but refers to a parameter setting related to a trade-off between a printing time and contrast of printing.

Here, among the plurality of different laser printing methods, the laser printing methods which are selectively used according to the hue of the printing performed on the workpiece W or the surface state of the workpiece W include, for example, as illustrated in FIGS. 4 and 5, a black carving method (black carving), a white carving method (white carving), a glossy method 1 (glossy 1), a glossy method 2 (glossy 2), a deep engraving method (deep engraving), a shallow engraving method (engraving), and black carving only for a two-dimensional code (code: black).

Here, the black carving method is so-called black printing. The black printing is a method in which the workpiece W is deeply carved by laser light, and as a result, a carving trace is visualized in black. The white carving method is so-called white printing. The white printing is a method in which, as a result of shallowly carving the workpiece W, visible light is irregularly reflected on the surface of the workpiece W to appear white.

Both the glossy method 1 and the glossy method 2 are examples of black printing without unevenness. These methods are techniques in which an oxide film is formed on a metal surface constituting the workpiece W and visualized in black by the film. Since this technique is a method in which the surface of the workpiece W is not carved, the surface of the workpiece W is smooth even after printing. For example, in materials such as iron and SUS, printing conditions suitable for imparting gloss are different depending on a composition and a thickness of the workpiece W, and thus, it is possible to perform glossy printing corresponding to many workpieces W by selectively using the two printing methods.

The deep engraving method is a method of performing carving more deeply than the black carving method. The shallow engraving method is a method in which a plated surface of the workpiece W is scraped off to perform printing using color contrast between the plated surface and a base material exposed by scraping the plating off.

The black carving only for a two-dimensional code means a method in which the black carving method is used for a two-dimensional code such as a bar code or a QR code (registered trademark), and a white carving method is used for other characters, logos, and the like. In general, since the white carving method can be executed in a shorter time than the black carving method, the efficiency of the printing time can be improved by combining the white carving method and the black carving method.

On the other hand, among the plurality of different laser printing methods, the laser printing methods selectively used according to the hue of the workpiece W as the printing target include, for example, color developing printing (cool color) on a cool color-based workpiece W, color developing printing (warm color) on a warm color-based workpiece W, and color developing printing (black color) on a black color-based workpiece W as illustrated in FIGS. 4 and 5. Note that the “cool color” here includes at least white and blue. In addition, the “warm color” here includes at least red and yellow.

The warm color-based workpiece W is less likely to develop a color than the cool color-based workpiece W and the black color-based workpiece W. Therefore, the color developing printing on the warm color-based workpiece W corresponds to a method performed in just focus. On the other hand, the cool color-based and black color-based workpieces W are more likely to develop colors than the warm color-based workpiece W, but there is a possibility that printing is scorched in just focus. Therefore, the color developing printing on the cool color-based workpiece and black color-based workpieces W corresponds to a method performed in a defocused state.

From these methods, it is required to select an appropriate method according to a material of the workpiece W. For such selection, the storage unit 101 includes a method storage unit 101a in the present embodiment.

The method storage unit 101a stores one or more of the black carving method, the white carving method, the glossy method 1, the glossy method 2, the deep engraving method, and the shallow engraving method in association with each other, as the laser printing method selected by the second selection unit 106, for each material type selected by the first selection unit 105. Then, the second selection unit 106 displays a plurality of laser printing methods corresponding to the material type selected by the first selection unit 105 on the display unit 301 based on the contents stored in the method storage unit 101a. A specific example of the display contents will be described later.

Details of the association by the method storage unit 101a are as illustrated in FIG. 4.

For example, iron or SUS is associated with the black carving method, the white carving method, the glossy method 1, the glossy method 2, the deep engraving method, and the black carving only for a two-dimensional code. In addition, a casting surface of cast iron is associated with the black carving method and the white carving method. In addition, aluminum is associated with the black carving method, the white carving method, the deep engraving method, and the black carving only for a two-dimensional code. In addition, copper is associated with the black carving method, the white carving method, and the deep engraving method. In addition, alumite, gold plating, and silver plating are associated with the shallow engraving method. In addition, nickel plating and tin plating are associated with the glossy method 1 and the shallow engraving method. In addition, super steel, high-speed steel, and brass are associated with the black carving method and the white carving method.

In addition, ABS and other resins are associated with color developing printing for the cool color-based workpiece W, color developing printing for the warm color-based workpiece W, and color developing printing for the black color-based workpiece W.

Note that the meaning of the “plurality of different laser printing methods” is not limited to the above-described usage. For example, a usage of a parameter irrelevant to the printing time can be regarded as a usage of a laser printing method, and a usage of a parameter related to the printing time can be regarded as a usage of the printing quality.

Selection items for a laser printing method corresponding to a material type will be described with reference to a specific example. For example, when the control process proceeds from step S12 to step S13, the second selection unit 106 determines selection candidates for a laser printing method corresponding to the material type selected by the first selection unit 105 based on the contents stored in the method storage unit 101a.

Subsequently, when the control process proceeds from step S13 to step S14, the printing time calculation unit 108 calculates a printing time required to print the printing pattern Pp set by the input interface Iu for the workpiece W of the type selected by the first selection unit 105 for each laser printing method (selection candidate for a laser printing method) that needs to be selected by the second selection unit 106. Then, the second selection unit 106 displays a plurality of laser printing methods corresponding to the material type selected by the first selection unit 105 on the display unit 301 based on the contents stored in the method storage unit 101a.

In calculating the printing time, the printing time calculation unit 108 performs element decomposition of the printing pattern Pp in units of line segments. Thereafter, the printing time is calculated by adding the time required for scanning each element. Here, in the case of a method in which each line segment is repeatedly scanned (a method in which the number of times of printing is large), the printing time becomes relatively long. In addition, in the case of a method with a high scan speed, the printing time becomes relatively short. In addition, in the case of a method with a wide scanning line interval, the printing time becomes relatively long.

In addition, in selecting a laser printing method, it is possible to assist the user by not simply listing the respective methods but also displaying an image that evokes contents of the respective methods. In order to perform such assistance, the storage unit 101 includes an image storage unit 101b in the present embodiment.

The image storage unit 101b stores at least one of a preview image and an illustration showing each laser printing method for each laser printing method that needs to be selected by the second selection unit 106. Then, the second selection unit 106 displays a plurality of different laser printing methods on the display unit 301, and displays at least one of the preview image and the illustration in association with each of the laser printing methods displayed on the display unit 301 based on the contents stored in the image storage unit 101b. A specific example of the display contents will be described later.

For example, when the second interface 12 receives a click operation or the like on the fourth screen SC4 illustrated in FIG. 6D, the control process proceeds from step S14 to step S15.

Then, when the control process proceeds to step S15, the display contents of the display unit 301 transition from the fourth screen SC4 to a fifth screen SC5. Details of the fifth screen SC5 are as illustrated in FIG. 6E. The fifth screen SC5 is a screen for displaying the selection candidates for a laser printing method, the preview image and the illustration showing each laser printing method, and the printing time in each laser printing method.

As illustrated in FIG. 6E, in addition to the first interface I1 and the like described above, a name Pm of each laser printing method, a preview image Im1 corresponding to the laser printing method, an illustration Im2 corresponding to the laser printing method, and a printing time Ti required for the laser printing method are displayed on the fifth screen SC5. The preview image Im1 is an image corresponding to a plan view illustrating the presence or absence of color development, gloss, and the like of the printing pattern Pp. The illustration Im2 is an image corresponding to a cross-sectional view showing a focus position of printing laser light, a depth of carving, and the like. The preview image Im1 and the illustration Im2 can be referred to as “printing images” conceptualizing the laser printing method.

For example, in the case of the black carving method, the preview image Im1 suggesting that a character string has a black color is displayed. On the other hand, in the case of the white carving method, a preview image suggesting that a character string has a white color is displayed.

Since the printing images and the printing time are displayed side by side, even a user who is not accustomed to laser printing can select a laser printing method that is likely to achieves a desired appearance, the laser printing method being likely to complete printing within a desired time.

On the fifth screen SC5, only methods corresponding to the material type being selected (iron in the example of the drawing) are displayed. For example, a printing method that cannot be executed on the workpiece W made of iron, such as the color developing printing on a cool color-based workpiece W, is not displayed.

Then, the second selection unit 106 can be caused to select a laser printing method by performing a click operation or the like on any name Pm displayed on the display unit 301. As a result, the control process completes step S16 subsequently to step S15.

For example, by performing a click operation or the like on the name Pm of the “black carving method”, it is possible to cause the second selection unit 106 to select the “black carving method” as a type of a laser printing method. Thereafter, when the second interface 12 receives a click operation or the like again, the display contents of the display unit 301 transition from the fifth screen SC5 to a sixth screen SC6. Details of the sixth screen SC6 are as illustrated in FIG. 6F.

As illustrated in FIG. 6F, the sixth screen SC6 has the same configuration as the fourth screen SC4 in FIG. 6D except for display contents related to the second interface 12. As a difference from the fourth screen SC4, the second interface 12 of FIG. 6F displays that a type of a laser printing method is the “black carving method” and displays the preview image Im1 and the illustration Im2 corresponding to the black carving method, and a printing time Ti required for the black carving method.

Note that there is an element called printing quality as a concept independent of a laser printing method as described above. The printing quality affects a length of the printing time. There may also be a user who wishes to adjust such printing quality.

The printing quality can be selected through the third selection unit 107 described above. The third selection unit 107 displays the printing quality in the laser printing method selected by the second selection unit 106 on the display unit 301 as a plurality of different quality levels, and selects one of the quality levels based on a user operation. Note that the selection by the third selection unit 107 is not essential.

In addition, the selection of the quality level can be performed individually for each printing pattern Pm instead of simultaneously for all the printing contents of the workpiece W. As a result, it is possible to perform printing with high quality with sufficient time for some printing patterns (for example, a two-dimensional code) Pm in which the user places emphasis on the quality, and to perform printing in a shorter time for the printing pattern Pm for which the quality is not so emphasized. As a result, the usability of the laser printing apparatus L can be improved.

For example, when the third interface 13 receives a click operation or the like on the sixth screen SC6 illustrated in FIG. 6F, the control process proceeds from step S16 to step S17.

Then, when the control process proceeds to step S17, the display contents of the display unit 301 transition from the sixth screen SC6 to a seventh screen SC7. Details of the seventh screen SC7 are as illustrated in FIG. 6G. The seventh screen SC7 is a screen for receiving an operation of selecting a quality level.

As illustrated in FIG. 6G, the seventh screen SC7 displays a ninth interface 19 and a tenth interface 110 in addition to the first interface I1 and the like described above. Each of these interfaces corresponds to a selection item for a quality level. Specifically, the ninth interface 19 is an interface for selecting a quality level of a character string or a logo in the printing pattern Pp. The tenth interface 110 is an interface for selecting a quality level of a two-dimensional code (2D code) in the printing pattern Pp.

For example, when the ninth interface 19 receives a click operation or the like, the display contents of the display unit 301 transition from the seventh screen SC7 to an eighth screen SC8. Details of the eighth screen SC8 are as illustrated in FIG. 6H.

As illustrated in FIG. 6H, on the eighth screen SC8, the display contents of the ninth interface 19 are unfolded so that selection items for a quality level are displayed. The selection items include “quality priority” selected when the printing quality is prioritized, “speed priority” selected when the printing sped is prioritized, and “recommended” obtained by balancing the printing quality and the printing sped. “Recommended” may be used for initial setting of a quality level. In addition, the printing time calculated by the printing time calculation unit 108 is displayed together for each quality level next to each item. Such a display mode is similar also in a case where the tenth interface 110 receives a click operation or the like. In addition, the display contents of the ninth interface 19 are an example, and it is also possible to display the selection items in other expressions. For example, the selection item selected when the printing quality is prioritized may be “quality emphasis”, and the selection item selected when the printing sped is prioritized may be “speed emphasis”.

For example, a case where the ninth interface 19 is changed to “speed priority” and “recommended” is held for the tenth interface 110 is considered. In this case, as illustrated in FIG. 6I, the printing time Ti displayed on the second interface 12 is changed to a shorter time by the change of the ninth interface 19 to “speed priority”.

In addition, the printing controller 100 according to the present embodiment can also provide an interface for changing a parameter not involved in the printing time among parameters similar to the printing quality. An example of such an interface is the eleventh interface I11 in FIG. 6J. The eleventh interface I11 can adjust a level of the laser power as an example of the parameter not involved to the printing time.

In addition, interfaces for changing the defocus amount and the Q-switch frequency as parameters not involved in the printing time may be provided. The presence or absence of such interfaces may be selectable according to a material type of the workpiece W. For example, as illustrated in FIG. 6I, in a case where the material type of the workpiece W belongs to a resin, the interface for changing the parameter not involved in the printing time may be provided.

Finally, when the fifth interface 15 receives a click operation or the like in a state where the material type, the laser printing method type, and the quality level as necessary are selected, the control process proceeds to step S18.

In step S18, the printing condition setting unit 104 sets a printing condition. Specifically, the printing condition setting unit 104 sets the printing condition for printing the printing pattern Pm on the workpiece W of the material type by the laser printing method based on the printing pattern Pm set by the input interface Iu, the material type selected by the first selection unit 105, and the laser printing method type selected by the second selection unit 106.

More specifically, in step S18, the printing condition setting unit 104 sets the printing condition based on the quality level selected by the third selection unit 107 in addition to the printing pattern Pm set by the input interface Iu, the material type selected by the first selection unit 105, and the laser printing method type selected by the second selection unit 106.

Details of the setting by the printing condition setting unit 104 are as illustrated in FIG. 5.

First, the case of the black carving method (black carving) will be described. In this case, the scan speed is set to be relatively slow in order to apply sufficient heat to the same location. The scan speed is set to, for example, about 100 to 300 mm/s. In addition, the defocus amount is set to zero (that is, just focus). In addition, the number of times of printing is set to be relatively small. The number of times of printing is set to, for example, about twice. In addition, the laser power is set to be relatively high so as to carve the workpiece W deeply. The laser power is set to, for example, about 80%. The scanning line interval is set to be substantially equal to a spot diameter of the printing laser light. The scanning line interval is set to, for example, about 0.05 mm. Note that, in the example in the drawing, an output parameter using % is set as the laser power, but the output parameter of the laser power is not limited to a relative parameter of %. For example, an absolute parameter such as a current amount may be used.

Next, the case of the white carving method (white carving) will be described. In this case, the scan speed is set to be relatively fast such that the same location is not excessively heated. The scan speed is set to, for example, 1000 mm/s or more. In addition, the defocus amount is set to zero (that is, just focus). In addition, the number of times of printing is set to be relatively small. The number of times of printing is set to, for example, about twice. In addition, the laser power is set to be relatively high as in the black carving method. The laser power is set to, for example, about 80%. The scanning line interval is set to be slightly larger than the spot diameter of the printing laser light. The scanning line interval is set to, for example, about 0.06 mm.

Next, the case of the glossy method 1 will be described. In this case, the scan speed is set to be relatively fast. The scan speed is set to, for example, 1000 mm/s or more. In addition, the defocus amount is set to a non-zero value such that the workpiece W is not carved by the printing laser light. In addition, the number of times of printing is set to be relatively large. The number of times of printing is set to, for example, about five times. In addition, the laser power is set to be relatively high. The laser power is set to, for example, about 80%. The scanning line interval is set to be about the same as or slightly smaller than the spot diameter of the printing laser light. The scanning line interval is set to, for example, about 0.04 to 0.05 mm.

Next, the case of the glossy method 2 will be described. In this case, the scan speed is set to be relatively slow. The scan speed is set to, for example, about 100 to 300 mm/s. In addition, the defocus amount is set to a non-zero value such that the workpiece W is not carved by the printing laser light. In addition, the number of times of printing is set to be relatively small. The number of times of printing is set to, for example, about twice. In addition, the laser power is set to be relatively high. The laser power is set to, for example, about 80%. The scanning line interval is set to be about the same as or slightly smaller than the spot diameter of the printing laser light. The scanning line interval is set to, for example, about 0.04 to 0.05 mm.

Next, the case of deep engraving will be described. In this case, the scan speed is set to be relatively slow. The scan speed is set to, for example, about 100 to 300 mm/s. In addition, the defocus amount is set to zero (that is, just focus). In addition, the number of times of printing is set to be relatively large. The number of times of printing is set to, for example, about five times. In addition, the laser power is set to be relatively high. The laser power is set to, for example, about 80%. The scanning line interval is set to be substantially equal to a spot diameter of the printing laser light. The scanning line interval is set to, for example, about 0.05 mm.

Next, a case of black only for a code will be described. In this case, the scan speed may be set to be fast or slow. The scan speed may be set to, for example, about 100 to 300 mm/s or may be set to 1000 mm/s or more. In addition, the defocus amount is set to zero (that is, just focus). In addition, the number of times of printing is set to be relatively small. The number of times of printing is set to, for example, about twice. In addition, the laser power is set to be relatively high. The laser power is set to, for example, about 80%. The scanning line interval is set to be about the same as or slightly larger than the spot diameter of the printing laser light. The scanning line interval is set to, for example, about 0.05 to 0.06 mm.

Next, the case of carving will be described. In this case, the scan speed is set to be relatively fast. The scan speed is set to, for example, 1000 mm/s or more. In addition, the defocus amount is set to zero (that is, just focus). In addition, the number of times of printing is set to be relatively small. The number of times of printing is set to, for example, about twice. In addition, the laser power is set to be relatively high. The laser power is set to, for example, about 80%. The scanning line interval is set to be substantially equal to a spot diameter of the printing laser light. The scanning line interval is set to, for example, about 0.05 mm.

Next, the case of color developing printing (cool color) on the cool color-based workpiece W will be described. In this case, the scan speed is set to be relatively fast. The scan speed is set to, for example, 1000 mm/s or more. In addition, the defocus amount is set to a non-zero value such that the workpiece W is not scorched by the printing laser light. In addition, the number of times of printing is set to be relatively small such that the workpiece W is not scorched. The number of times of printing is set to, for example, about twice. In addition, the laser power is set to be relatively low such that the workpiece W is not scorched. The laser power is set to, for example, about 30%. The scanning line interval is set to be slightly larger than the spot diameter of the printing laser light. The scanning line interval is set to, for example, about 0.06 mm.

Next, the case of color developing printing (warm color) on the warm color-based workpiece W will be described. In this case, the scan speed is set to be relatively fast. The scan speed is set to, for example, 1000 mm/s or more. In addition, the defocus amount is set to a non-zero value such that the workpiece W is not scorched by the printing laser light. In addition, the number of times of printing is set to be relatively small such that the workpiece W is not scorched. The number of times of printing is set to, for example, about twice. In addition, since a warm color-based resin is less likely to develop a color than a cool color-based resin, the laser power is set to be relatively high. Since the defocus amount is set to the non-zero value and the laser power is set to be relatively high, it is possible to more reliably develop a color while suppressing scorching of the workpiece W. The scanning line interval is set to be slightly larger than the spot diameter of the printing laser light. The scanning line interval is set to, for example, about 0.06 mm. Note that, in the color developing printing (warm color), it is possible to perform the printing in which scorching is suppressed by providing the defocus amount set to the non-zero value, but it is not essential to set the defocus amount to the non-zero value. It is also possible to perform the printing with a defocus amount of 0.

Next, the case of color developing printing (black color) on the black color-based workpiece W will be described. In this case, the scan speed is set to be relatively fast. The scan speed is set to, for example, 1000 mm/s or more. In addition, the workpiece W is not scorched by the printing laser light. In this case, the scan speed is set to be relatively fast. The scan speed is set to, for example, 1000 mm/s or more. In addition, the defocus amount is set to a non-zero value such that the workpiece W is not scorched by the printing laser light. In addition, the number of times of printing is set to be relatively small such that the workpiece W is not scorched. The number of times of printing is set to, for example, about twice. In addition, the laser power is set to be lower than that in the color developing printing on the cool color-based workpiece W such that the workpiece W is not scorched. The scanning line interval is set to be slightly larger than the spot diameter of the printing laser light. The scanning line interval is set to, for example, about 0.06 mm.

Here, returning to FIGS. 6A to 6J, when the fourth interface 14 receives a click operation or the like, the printing condition setting unit 104 according to the present embodiment executes processing related to so-called sample printing.

In general, there are many parameters that characterize the printing laser light as in the above-described printing condition. Adjusting such parameters one by one requires labors, and thus, is inconvenient.

Therefore, the printing condition setting unit 104 according to the present embodiment sets two parameters among a plurality of different parameters constituting the printing condition as variable parameters, sets the remaining parameter as fixed parameter, and changes the variable parameters, thereby generating a plurality of different printing conditions. At that time, for each laser printing method that needs to be selected by the second selection unit 106, the printing condition setting unit 104 selects variable parameters corresponding to the laser printing method.

That is, only the two parameters among the plurality of different parameters constituting the printing condition are set as the variable parameters. As a result, appropriate parameters can be searched in a two-dimensional matrix. Thus, it is possible to save the user's time and effort. In addition, the variable parameters can be more appropriately selected by selecting parameters corresponding to the laser printing method as the variable parameters.

### SUMMARY

As described above, the laser printing apparatus L according to the present embodiment causes the first selection unit 105 to select a type of a material, then causes the display unit 301 to display a plurality of different laser printing methods corresponding to the type, and causes the second selection unit 106 to select one of the plurality of different laser printing methods as illustrated in step S12 to step S16 of FIG. 3 and FIGS. 4, 6C, 6E, and the like. As a result, options can be displayed in stages, and the number of options simultaneously displayed on the display unit 301 can be reduced. This is effective in terms of ensuring the usability of the laser printing apparatus L. In addition, there is no change in selecting each of the material type and the laser printing method type, and thus, the printing condition can be appropriately set. In this manner, the printing condition can be appropriately set without impairing the usability of the laser printing apparatus L according to the present embodiment.

In addition, the laser printing apparatus L according to the present embodiment further considers the quality level in addition to the material type and the laser printing method type as illustrated in step S17 of FIG. 3 and FIGS. 6G, 6J, 6I, and the like. As a result, the printing condition can be set more appropriately.

In addition, the laser printing apparatus L according to the present embodiment displays the printing time in association with each of the laser printing methods as illustrated in steps S14 to S15 of FIG. 3 and FIG. 6E and the like. As a result, even the user who is not accustomed to laser printing can set the printing condition so as to fall within a desired printing time. Thus, the usability of the laser printing apparatus L can be improved.

In addition, the laser printing apparatus L according to the present embodiment displays the preview image Im1 and the illustration Im2 in association with each of the laser printing methods as illustrated in step S15 of FIG. 3 and FIG. 6E and the like. As a result, even the user who is not accustomed with laser printing can set the printing condition so as to achieve a desired appearance. Thus, the usability of the laser printing apparatus L can be improved.

In addition, the variable parameters can be automatically selected in association with each of the laser printing methods as described in relation to the fourth interface 14. As a result, it is possible to more efficiently search for parameters in further tuning of the printing condition. Thus, the usability of the laser printing apparatus L can be improved.

### Other Embodiments

In the above embodiment, for each laser printing method, the printing time Ti for printing by the method is displayed as illustrated in FIG. 6E, but the disclosure is not limited to such a configuration. Instead of the configuration of displaying the printing time Ti or in addition to the configuration of displaying the printing time Ti, a display order of the laser printing methods on the fifth screen SC5 may be arranged in order from a method in which the printing time Ti is shorter. In the example of FIG. 6E, the respective methods are displayed in the order of the white carving method, the black carving method, and the glossy method from the top of the fifth screen SC5.

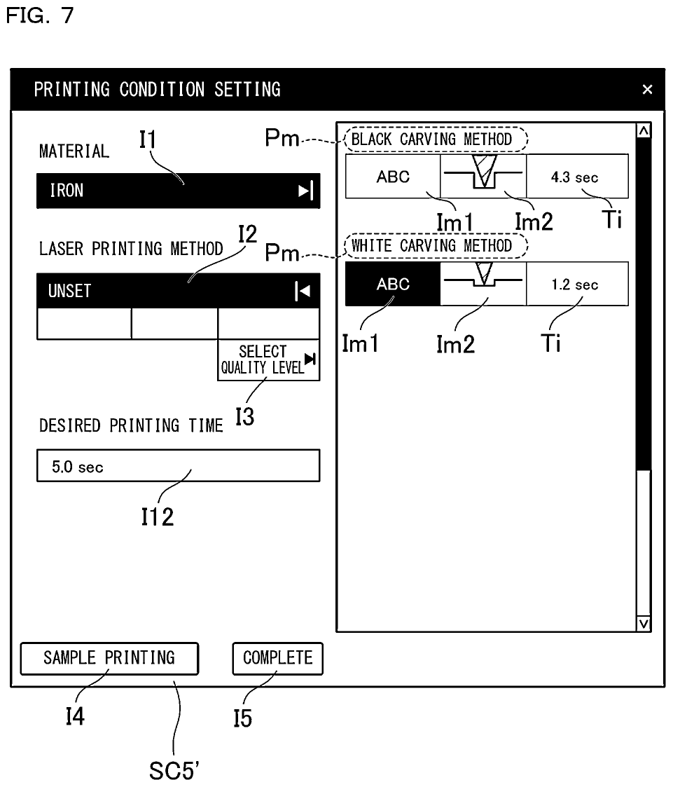

FIG. 7 is a view corresponding to FIG. 6E, which illustrates a modification of the display screen. As in a display screen SC5′ illustrated in FIG. 7, a twelfth interface 112 for receiving an input of a desired printing time may be provided in the display screen SC5′. For example, when printing within 5.0 seconds is desired, the user inputs “5.0” to the twelfth interface 112. Then, as illustrated in the right half of the display screen SC5′, a laser printing method in which the printing time Ti exceeds the desired printing time (=5.0 seconds) is hidden, and only a laser printing method in which the printing time Ti is equal to or less than the desired printing time is displayed. At that time, a numerical value of the printing time Ti may be hidden.

Alternatively, instead of the example in the right half of FIG. 7, the laser printing method in which the printing time Ti is equal to or less than the desired printing time may be displayed with emphasis (for example, highlighted), and the laser printing method in which the printing time Ti exceeds the desired printing time may be maintained without being hidden.

What is claimed is:

1. A laser printing apparatus that controls a laser light output unit and a laser light scanning unit to print a predetermined printing pattern in a printing region, the laser printing apparatus comprising:
the laser light output unit that generates laser light based on excitation light and outputs the laser light;
a laser light scanning unit irradiates a printing target with the laser light output from the laser light output unit and performs two-dimensional scanning in the printing region on a surface of the printing target;
a display unit that displays a setting plane corresponding to the printing region;
a printing pattern setting unit that sets the printing pattern on the setting plane displayed on the display unit;
a first selection unit that displays a plurality of different types of materials forming the printing target on the display unit, and selects any one type based on a user operation;
a second selection unit that displays, based on the type of a material selected by the first selection unit, a plurality of different types of laser printing methods corresponding to the printing target of the type on the display unit, and selects any one laser printing method based on a user operation; and
a printing condition setting unit that sets a printing condition for printing the printing pattern on the printing target of the type of the material by the laser printing method based on the printing pattern set by the printing pattern setting unit, the type of the material selected by the first selection unit, and a type of the laser printing method selected by the second selection unit.

2. The laser printing apparatus according to claim 1, further comprising
a method storage unit that stores one or more of a black carving method, a white carving method, a glossy method, a deep engraving method, and a shallow engraving method in association with each other, as the laser printing method selected by the second selection unit for each type of a material selected by the first selection unit,
wherein the second selection unit displays a plurality of laser printing methods corresponding to the type of the material selected by the first selection unit on the display unit based on a content stored in the method storage unit.

3. The laser printing apparatus according to claim 1, further comprising
a third selection unit that displays a printing quality in the laser printing method selected by the second selection unit as a plurality of different quality levels on the display unit, and selects any one quality level based on a user operation,
wherein the printing condition setting unit sets the printing condition based on the quality level selected by the third selection unit in addition to the printing pattern set by the printing pattern setting unit, the type of the material selected by the first selection unit, and the type of the laser printing method selected by the second selection unit.

4. The laser printing apparatus according to claim 1, further comprising
a printing time calculation unit that calculates a printing time required for printing the printing pattern set by the printing pattern setting unit on the printing target of the type selected by the first selection unit for each laser printing method that needs to be selected by the second selection unit,
wherein the second selection unit displays the plurality of different laser printing methods on the display unit, and displays the printing time calculated by the printing time calculation unit in association with each of the laser printing methods displayed on the display unit.

5. The laser printing apparatus according to claim 1, further comprising
an image storage unit that stores at least one of a preview image and an illustration showing each laser printing method for each laser printing method that needs to be selected by the second selection unit,
wherein the second selection unit displays the plurality of different laser printing methods on the display unit, and displays at least one of the preview image and the illustration in association with each of the laser printing methods displayed on the display unit based on a content stored in the image storage unit.

6. The laser printing apparatus according to claim 1, wherein
the printing condition setting unit
sets two parameters among a plurality of different parameters constituting the printing condition as variable parameters, sets a remaining parameter as a fixed parameter, and changes the variable parameters to generate a plurality of different printing conditions, and
selects, for each laser printing method that needs to be selected by the second selection unit, the variable parameters corresponding to the laser printing method.
